(19) United States
(12) Patent Application Publication
(10) Pub. No.: US 2026/0233134 A1
(43) Pub. Date: Aug. 13, 2026

(54) APPARATUS AND METHOD FOR SOLID-LIQUID SEPARATION

(71) Applicant: Betolar Oyj, Kannonkoski (FI)

(72) Inventor: Ari Laitinen, Kannonkoski (FI)

(21) Appl. No.: 19/471,151

(22) PCT Filed: Mar. 27, 2024
(86) PCT No.: PCT/FI2024/050151

§ 371 Date: Sep. 30, 2025

(30) Foreign Application Priority Data
Mar. 30, 2023 (FI) 20235364

(51) Int. Cl. B01D 33/052; B01D 33/04; B01D 33/72; B01D 33/74; B01D 39/20

(52) U.S. Cl. CPC B01D 33/052; B01D 33/04; B01D 33/72; B01D 33/742; B01D 39/2065; B01D 2201/0415; B01D 2201/36; B01D 2239/0208; B01D 2259/80

(57) ABSTRACT

An apparatus and method for solid-liquid separation. Sludge (4) containing solid particles and liquid is fed on a moving belt (2) which is made of liquid permeable filtering material. Acoustic waves (12) are directed to the sludge for intensifying the separation. One or more acoustic wave generators (11) are provided for producing the acoustic waves.

### BACKGROUND OF THE INVENTION

The invention relates to an apparatus for solid-liquid separation.

The invention relates also to a method for providing solid-liquid separation.

The object of the invention is described in more detail in the preambles of independent claims of the application.

Solid-liquid separation is a process wherein two phases, solid and liquid, are separated from a suspension or sludge. Several different techniques and apparatuses have been designed for the purpose. However, the known solutions have shown some drawbacks.

### BRIEF DESCRIPTION OF THE INVENTION

The idea of the invention is to provide a new and improved apparatus and method for solid-liquid separation. The characteristic features of the apparatus according to the invention are set forth in the characterizing part of the first independent claim.

The characteristic features of the method according to the invention are set forth in the characterizing part of the second independent claim.

The idea of the proposed solution is to provide an apparatus for solid-liquid separation. The apparatus utilizes a permeable belt and acoustic waves in separation of liquid from fine particles. In other words, solidification is intensified by means of acoustic waves. The acoustic waves may cause vibrations in the sludge material to be filtered and also in the belt. The acoustic waves can generate acoustic oscillation of pressure in materials which are subjected to the waves. Of course, the acoustic waves are directed to a belt section on which the sludge to be filtered is transported in the apparatus.

The apparatus comprises: an endless belt configured to be driven around at least two rotating rolls and wherein the belt is made of liquid permeable filter medium material; a receiving section wherein sludge to be filtered is configured to be fed on an upper surface of the belt; a discharge section wherein solid material separated from the fed sludge is configured to discharged from the upper surface of the belt; and one or more tray structures below the belt for receiving liquid passing through the belt. The apparatus further comprises: one or more acoustic wave generators for producing acoustic waves and are arranged to direct the acoustic waves towards the sludge to be filtered; and the belt is in gaseous atmosphere whereby medium for propagation of the acoustic waves is gas.

Acoustic waves need a medium to travel. In this solution the acoustic waves are traveling in gaseous atmosphere. Therefore, at least the belt section where the sludge is transported and wherein the solidification occurs, is surrounded by gas.

An advantage of the disclosed solution is that structure of the apparatus for increasing dry solids content is simple, whereby it is inexpensive, durable and requires only little service. Further, implementation of the acoustic wave generator requires no extensive modifications to basic structure of a belt filter whereby the disclosed solution is easy and inexpensive to provide. The acoustic wave generator can also be retrofitted to existing belt filters.

Furthermore, the at least one acoustic wave generator is located above the belt. In other words, the sludge to be filtered is between the belt and the one or more acoustic wave generators. Then energy of the acoustic waves is directed well to the sludge and effectively intensifies the filtering.

According to an embodiment, the apparatus is suitable for processing gypsum sediments and refining tailings or refining of ore, for example.

According to an embodiment, the apparatus may be designed to process sludges comprising water as the liquid. Then the apparatus is a dewatering apparatus.

According to an embodiment, the sludge to be processed may also be called as slurry, suspension, or debris. According to an embodiment, the apparatus can serve as a pre-dewatering device suitable for treating materials being too loose to be treated by means of conventional dewatering devices, such as nips and press rolls. The pre-treated material handled by the acoustic dewatering device can be further processed in other mechanical or thermal dewatering devices, for example. The acoustic dewatering solution suits well for use as a first dewatering phase for loose and wet materials.

According to an embodiment, the material to be treated may comprise other liquids than water, such as methanol, ethanol, oils, or other industrial liquid substances. In this document the term dewatering refers also to solid-liquid separation of other liquids than water from treated materials and sludges. The treated material may comprise compositions of industrial liquids and solid matters, side stream materials and liquids, and waste materials and liquids, for example.

According to an embodiment, the apparatus is a continuously operating acoustic belt filter.

According to an embodiment, the apparatus may be without mechanical pressing means for pressing the sludge material during the filtration process.

According to an embodiment, the apparatus comprises several acoustic wave generators.

According to an embodiment, the wave generator of the apparatus produces acoustic waves provided with acoustic pressure. The acoustic pressure or sound pressure can be considered as the force of sound on a surface area perpendicular to the direction of the sound.

According to an embodiment, control parameters for controlling the apparatus and the solidification process may be: acoustic frequency, acoustic pressure (or sound pressure), distance from the target, orientation of the acoustic wave generator in relation to the target, used gas medium, used material of the belt, belt speed, feed rate of the sludge, for example.

According to an embodiment, the acoustic wave generator is configured to produce infrasound with frequency below 20 Hz. The acoustic frequency infrasound means generally low frequency sound and describes sound waves with a frequency below the lower limit of human audibility.

According to an embodiment, the acoustic wave generator is configured to produce acoustic waves having frequency on range of audible sound.

It has been noted that use of ultrasound requires liquid medium for travel of acoustic waves and cannot therefore be implemented in gaseous atmosphere.

According to an embodiment, the apparatus may implement infrasound and audible sound i.e., it may combine different wave frequencies. The apparatus may comprise two, three or even more sections wherein different frequency is implemented. For example, one section may use infrasound and another section may use audible sound. It is also possible that the frequency may be adjusted at each section independently case by case. In case they sections are provided with wave reflectors they can also be adjusted independently. The adjustment of the frequency and the reflectors can be made automatically by means of one or more control units.

According to an embodiment, the apparatus comprises several consecutive solid-liquid separation zones, spaces, sections, or separation spaces.

According to an embodiment, the apparatus comprises one or more solid-liquid separation zones, spaces or sections wherein ambient air prevails. Then the belt and the sludge to be processed are in ambient air. In other words, the apparatus is operating in normal operating conditions in the ambient air. Then there is no need for any special arrangements.

According to an embodiment, the apparatus is configured to be operated at atmospheric pressure. In other words, there is no suction below the belt, or over pressure on a cake side for assisting the dewatering. Thus, the acoustic waves and gravity are implemented for the process of separating liquid from the solid particles or material.

According to an embodiment, the apparatus is located at a factory site and operates at production scale, Thus, the apparatus is designed especially for production scale.

According to an alternative embodiment, the apparatus may be designed for laboratory use.

According to an embodiment, the one or more acoustic wave generators are located so that they affect at a relatively large range in a movement direction of the belt. In other words, not only a limited area above the belt is provided with the acoustic waves but a large area is subjected to affects of the acoustic waves.

According to an embodiment, an effective range covered by the acoustic waves of the one or more acoustic wave generators extends to an entire distance between rolls around which the belt is running.

According to an embodiment, at least majority of a distance between rolls around which the belt is running is covered by the effects of the one or more acoustic wave generators.

According to an embodiment, the apparatus comprises an additional dewatering device in addition to the acoustic wave generator. Then the one or more acoustic wave generators are located before the additional dewatering device when examined in the movement direction of the belt. Thus, a nip or other further drying device is arranged only after the acoustic dewatering. The acoustic dewatering can remove water from the material so that after the acoustic treatment the material can be treated in the conventional dewatering or solid liquid separation devices.

According to an embodiment, the apparatus comprises at least one acoustic wave generator arranged below the belt.

According to an embodiment, the apparatus comprises at least one acoustic wave generator arranged above the belt and at least one acoustic generator arranged below the belt. Thus, there may be one or more acoustic wave generators on both sides of the belt transporting the sludge.

According to an embodiment, the apparatus is a pressure belt filter wherein pressure difference is generated between opposite sides of the belt carrying the sludge to be filtered. In other words, there may be one or more suction boxes for producing suction below the belt, or pressure means for generating pressure on a cake side for assisting the dewatering. Thus, the acoustic waves, pressure difference, and gravity are all implemented for the process of separating liquid from the solid particles or material.

According to an embodiment, the belt comprises carbon fibre material. It has been noted in several tests that belts with the carbon fibre material provides efficient support for the filtrated material and shock resistance properties. A further advantage is that it has good self-cleaning properties. Fine particles do not accumulate to the belt structure.

According to an embodiment, the belt may made of carbon fibre material, or may comprise carbon fibre material which tolerates well stresses whereby the belt can be stressed to be tight when being driven around the rolls. The stressed belt provides good support for the material being handled which intensifies effects of the acoustic waves.

According to an embodiment, the belt comprises carbon based belt material.

According to an embodiment, the belt may or may not comprise an additional support layer, or support belt, below the carbon fibre belt, or combined with the structure of the carbon fibre belt.

According to an embodiment, the belt is formed of any suitable liquid permeable material being hydrophobic and strength enough for serving as belt material.

According to an embodiment, the acoustic wave generator comprises: at least one signal generator for producing signals; at least one amplifier for amplifying the produced signals; and at least one loudspeaker for producing acoustic waves in response to the received amplified signals.

According to an embodiment, the acoustic wave generator comprises at least one mechanical acoustic wave generator.

According to an embodiment, the acoustic wave generator comprises at least one mechanical siren.

According to an embodiment, the acoustic wave generator comprises at least one pneumatic acoustic wave generator.

According to an embodiment, the acoustic wave generator may comprise at least one acoustic device operated by means of chemical energy, such as liquefied petroleum gas (LPG) or other hydrocarbons or hydrogen. The reactive gas components are subjected to pulse-like burn or explosion so that acoustic waves are generated. Thus, the acoustic wave generator is a device configured to generate pulse-like acoustic waves by means of gas component burning or explosion.

According to an embodiment, the apparatus is provided with a sound absorbing arrangement surrounding the apparatus for preventing the acoustic waves spreading to the environment surrounding the apparatus. Thus, the apparatus may comprise means for preventing the surroundings from noise and possible other harmful effects of the acoustic waves.

According to an embodiment, the apparatus comprises at least one acoustic wave reflector below the belt for reflecting the acoustic waves backwards and for producing reflected waves.

According to an embodiment, the mentioned acoustic wave reflector may be a metallic structure or other rigid element capable of serving as a reflecting surface or structure.

According to an embodiment, the tray arranged below the transporting and filtering section of the belt may serve as the acoustic wave reflector.

According to an embodiment, the structure and material of the tray serving as the reflector may be selected so that the tray has rigid enough structure being capable to reflect the waves in a desired manner.

According to an embodiment, the apparatus comprises a first adjusting arrangement for adjusting distance of the wave generator from the belt and the sludge on the belt.

According to an embodiment, the apparatus comprises a second adjusting arrangement for adjusting distance of the sound reflector from the belt and the sludge on the belt.

According to an embodiment, the apparatus comprises a third adjusting arrangement for adjusting orientation of the acoustic wave generator in relation to surfaces of the belt and the sludge on the belt.

According to an embodiment, the third adjusting arrangement for adjusting orientation of the acoustic wave generator can adjust the orientation in relation to one or two turning axis or both.

According to an embodiment, the third adjusting arrangement for adjusting orientation of the acoustic wave generator can adjust the orientation and provide swinging turning movements for the acoustic wave generator. This way pulsating acoustic waves can be directed to the material being treated.

According to an embodiment, the apparatus comprises a fourth adjusting arrangement for adjusting orientation of the wave reflector in relation to surfaces of the belt and the sludge on the belt.

According to an embodiment, the apparatus comprises at least one wave absorber on the opposite side of the belt compared to position of the acoustic wave generator. The wave absorber is for preventing undesired reflecting waves from machine parts, for example. This way possible disrupting acoustic waves can be dampened and more controlled wave control is achieved.

According to an embodiment, an upper surface of the absorber facing towards the belt is provided with sharp shaped elements such as cone or pyramid shapes. Further, material of the absorber may be soft (not rigid) which also facilitates the absorbing features.

According to an embodiment, the apparatus is provided with a hybrid solution comprising a combination of one or more absorbers and reflectors.

According to an embodiment, the apparatus is provided with at least one acoustic wave generator providing simultaneous blowing effect and acoustic wave pulsation.

According to an embodiment, one or more trays below the belt may comprise first areas serving as reflector areas and second areas serving as absorbing areas. This way a hybrid solution comprising reflector areas and absorbing areas is provided.

According to an embodiment, the disclosed solution may also relate to an acoustic unit or module comprising one or more acoustic wave generators. The acoustic unit or module may be mounted to an existing processing device, such as to a pulp dewatering device or belt filtering device. Then the acoustic unit or module may also be connected to a process control system of the existing process.

According to an embodiment, the disclosed solution relates also to a method for solid-liquid separation. The method comprises: using a belt filter for separating liquid and solid material from a sludge to be filtered; driving an endless belt, which is made of liquid permeable filter medium material, around at least two rotating rolls; feeding the sludge on an upper surface of the belt at a receiving section and discharging solid material at a discharge section; and collecting liquid penetrated through the liquid permeable belt underneath the belt. The method further comprises executing the solid-liquid separation in gaseous atmosphere and intensifying the solid-liquid separation by directing acoustic waves towards the sludge which is transported on the belt.

According to an embodiment, the method further comprises causing oscillation to solid particles of the sludge spread on the belt by means of the acoustic waves and intensifying penetration of the liquid through the permeable belt by means of the oscillation of the solid particles.

According to an embodiment, the acoustic waves cause pressure waves inside the threated material and may cause internal shaking which improves the solid-liquid separation process.

According to an embodiment, the sludge to be processed is homogeneous sludge comprising fine solid particles. Typically, this type of sludges are the most difficult sludges to be dewatered. However, the disclosed solution is capable of solidifying also this type sludges.

According to an embodiment, the sludge to be processed is one of the following: clay mud, refining tailings, gypsum sediment.

According to an embodiment, the apparatus is a mobile apparatus movable to different work sites. In other words, the apparatus can be transported to the work site according to a need and can be transported to a new work site when the work at the previous work site is completed.

According to an embodiment, the apparatus may comprise a pre-heating device for heating the material to be handled before feeding it on the belt whereby the acoustic dewatering is intensified. The material to be treated becomes more fluid when being pre-heated.

According to an embodiment, the apparatus may alternatively comprise a pre-cooling device for pre-cooling the material before the acoustic treatment on the belt.

According to an embodiment, the apparatus may comprise one or more feed devices for feeding chemicals to the material to be treated. The fed chemical may be for example sodium chloride NaCl, or some other chemicals or substances which improve dewatering properties of the material.

According to an embodiment, the apparatus is provided with a process control system for controlling at least the following process parameters: belt speed, feeding of the sludge, acoustic wave generator control (amplitude, frequency, and wave shape), distance and orientation of the acoustic wave generator, the reflector and the absorber in relation to the belt, geometries of the acoustic generator, the reflector and the absorber.

According to an embodiment, the acoustic wave generator comprises an acoustic wave guide for guiding the acoustic waves towards a material being treated.

An advantage of the acoustic wave guide is that the acoustic wave generator can be positioned and orientated more freely. Then the acoustic wave generator may be located at a greater distance from the belt and it is not always necessary to direct the acoustic wave generator towards the belt. Desing of the apparatus and location of machine parts may require the use of acoustic wave guides. Further, in special cases the acoustic wave generator can be located on the side of the belt and then the acoustic waves are still guided by means of the acoustic wave guides from above towards the treated material on the belt.

A further advantage of the use of the wave guide is that it may focus the generated acoustic waves to desired areas and may also direct them in desired angular orientation towards the material being treated.

According to an embodiment, the acoustic wave guide is connected to one acoustic wave generator and is used to transfer the acoustic power at a dewatering zone to one point.

According to an embodiment, one or more acoustic wave guides can be used to combine two or more acoustic wave generators to one channel for intensifying the acoustic power to be used in dewatering process.

According to an embodiment the acoustic wave guide can be used to divide the acoustic power to two or more channels to distribute the acoustic power to desired areas on the material being at the dewatering zone.

### BRIEF DESCRIPTION OF THE FIGURES

Some embodiments of the proposed solution are illustrated in more detail in the following figures, wherein

FIG. 1 is a schematic side view of an apparatus for solid-liquid separation,

FIG. 2 is a schematic and detailed side view of a solution wherein acoustic waves are generated and wherein an acoustic reflector is implemented,

FIG. 3 is a schematic diagram illustrating some features of the disclosed solution,

FIG. 4 is a schematic diagram illustrating some possible acoustic wave generators,

FIG. 5 is a schematic diagram showing possible frequencies of the acoustic waves usable in the present solution,

FIG. 6 is a schematic side view of a detail of an apparatus comprising two acoustic wave generators both provided with acoustic wave guides,

FIG. 7 is a schematic side view of a detail of an apparatus comprising one or more acoustic wave generators arranged above and below a belt section on which sludge in transported,

FIG. 8 is a schematic side view of an alternative apparatus for solid-liquid separation,

FIG. 9 is a schematic and detailed side view of a solution wherein position and orientation of an acoustic wave generator and an acoustic reflector are adjustable,

FIGS. 10 and 11 are schematic side views of some alternative apparatuses for solid-liquid separation,

FIG. 12 is a schematic side view of an apparatus provided with an acoustic wave generator module, and

FIG. 13 is a schematic view of an acoustic wave generator module seen from a side of a belt.

For the purpose of clarity, some embodiments of the proposed solutions are illustrated in the figures in a simplified form. The same reference numerals are used in the figures to refer to the same elements and features.

### DETAILED DESCRIPTION OF SOME EMBODIMENTS

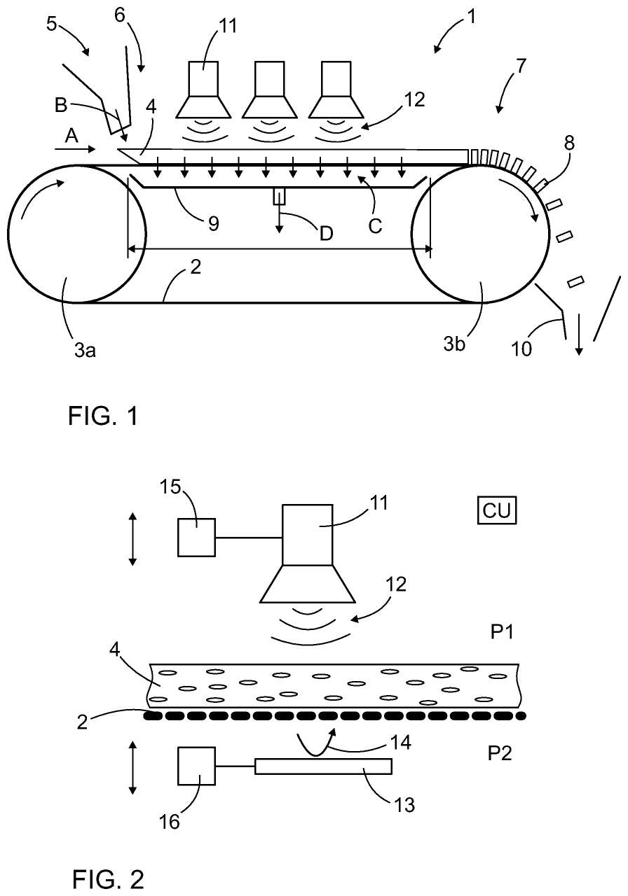

FIG. 1 discloses an apparatus 1 comprising an endless belt 2 which is driven around at least two rotating rolls 3a, 3b in direction A. The belt 2 is made of liquid permeable filter medium material. Sludge 4 to be filtered is fed B on an upper surface of the belt 2 from a feeding system 5. Thus, the belt 2 comprises a receiving section 6 wherein the sludge 4 is fed and a discharge section 7 wherein solid material 8 separated from the fed sludge 4 is configured to discharged from the upper surface of the belt 2. Below the belt 2 is one or more tray structures 9 for receiving liquid which is passing through the liquid permeable belt 2. Arrows C indicate direction of flow of liquid penetrating the belt 2 and an arrow D shows that the gathered liquid is flowing away from the apparatus 1. At the discharge end 7 there is discharge chute 10, a transport belt or any suitable system for receiving and handling the separated solid material 8 i.e., a cake.

The apparatus 1 further comprises one or more acoustic wave generators 11 for producing acoustic waves 12. The acoustic wave generators 11 arranged to direct the acoustic waves 12 towards the sludge 4 to be filtered. The acoustic waves 12 may cause internal shaking, movements, and vibrations for solid particles in the sludge 4 and can thereby intensify the liquid penetration. The belt 2 is in gaseous atmosphere whereby medium for propagation of the acoustic waves 12 is gas.

FIG. 2 discloses that below the belt 2 may be an acoustic wave reflector 13 for reflecting back 14 acoustic waves 12 which have passed through the belt 2. This way it is possible to further intensify the solid-liquid separation process. There may also be a first adjusting device 15 for adjusting distance between the acoustic wave generator 11 and the belt 2, and a second adjusting device 16 for adjusting distance between the acoustic wave reflector 13 and the belt 2. There may be at least one control unit CU for controlling the adjusting device 15, 16 as well as other operating devices of the disclosed apparatus.

FIG. 2 further discloses that on the sludge side of the belt 2 is prevailing pressure P1 and on the opposite side is prevailing pressure P2. The pressure P1 may be greater than the pressure P2 whereby the solid-liquid separation may be intensified by means of the pressure difference.

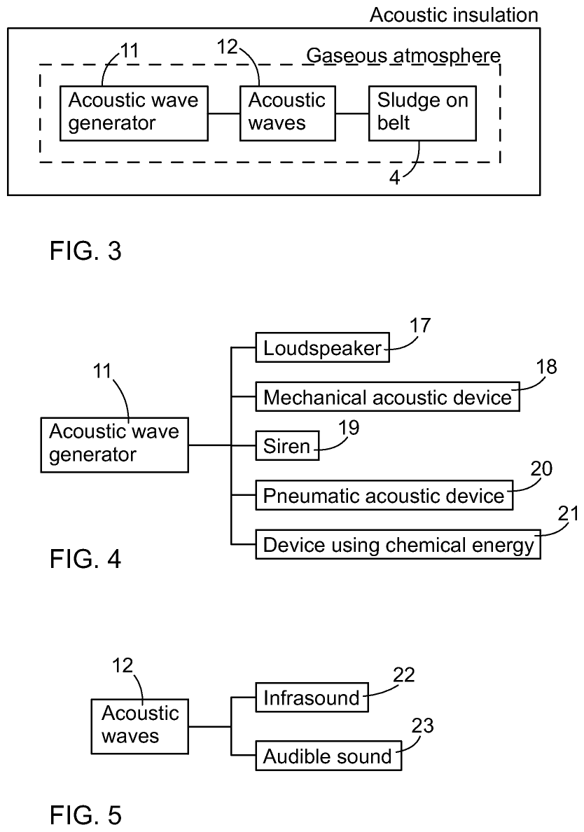

FIG. 3 discloses that the acoustic wave generator 11 produces acoustic waves 12 which are directed to the sludge 4 transported on the belt. The process is executed at gaseous atmosphere and the apparatus may be surrounded by a sound insulation system comprising acoustic insulation material or structure.

FIG. 4 discloses several possible acoustic wave generators 11 such as a loudspeaker 17, a mechanical acoustic device 18, a siren 19, a pneumatic acoustic device 20, or a device 21 which used chemical energy such as liquefied gas for producing the acoustic waves.

FIG. 5 discloses that the acoustic waves 12 may have infrasound 22 or audible sound 23 frequency.

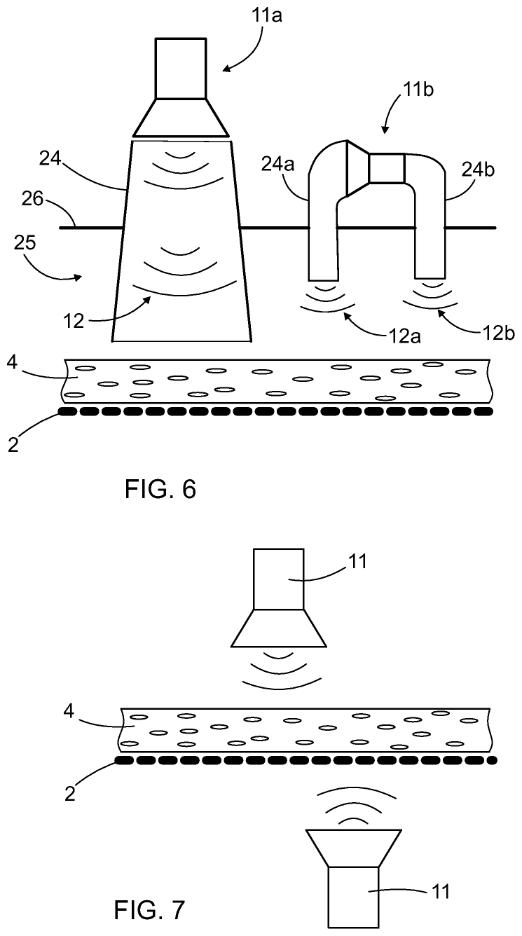

FIG. 6 discloses that an acoustic wave generator 11a may comprise an acoustic wave guide 24 for guiding the generated acoustic waves towards a belt 2 material or sludge 4 on it. Then the acoustic wave generator 11a may be located outside an inner space 25 limited by a basic structure of an apparatus i.e., outside upper covering elements 26. The acoustic wave guide 24 may be a tube or truncated cone, for example. By means of the acoustic wave guide 24 the generated acoustic waves 12 can be directed to desired areas and they can also be focused as desired by means of a shape of the acoustic wave guide 24.

FIG. 6 further discloses that there may an acoustic wave generator 11b which is also located outside the inner space 25 but is not orientated towards the belt 2. The acoustic wave generator 11b may have, for example, parallel orientation with the belt 2, or it may have any desired orientation. The acoustic wave generator 11b is provided with a first acoustic wave guide 24a for directing generated acoustic waves 12a towards the belt 2 despite of the orientation of the acoustic wave generator 11b. When the acoustic wave generator 11b is a loudspeaker, there may be a second acoustic wave generator 24b arranged on opposite site in relation to the first acoustic wave guide 24a. The second acoustic wave guide 24b may then be arranged to direct acoustic waves generated by returning sound generating element or loudspeaker cone. Then the acoustic waves generated in both directions of the sound generating element can be utilized in the solid-liquid separation process.

FIG. 7 discloses that the acoustic wave generators 11 may in some cases be mounted above and below the belt 2.

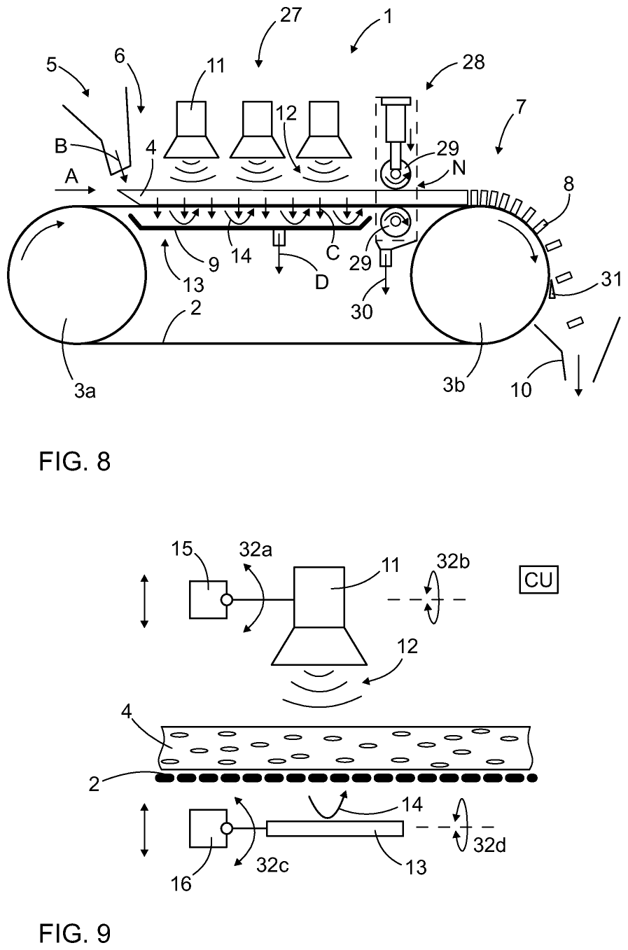

FIG. 8 discloses an apparatus 1 comprising an acoustic treatment section 27 and an additional solid-liquid separation device 28 following the acoustic treatment section 27. The additional solid-liquid separation device may comprise press-section wherein dewatering can be executed in a nip N i.e., between press rolls 29. Removed water or liquid is discharged through a discharge channel 30. Thus, the acoustic wave generators 11 are located before the press rolls 29. As can be noted, the acoustic wave section 27 covers a large range above the belt 2.

Alternatively, the additional solid-liquid separation device may comprise a press filter belt.

FIG. 8 further discloses that a tray 9 below the belt 2 may be arranged to serve as a reflector 13 so that the acoustic waves passing through the sludge 4 and the belt 2 can be reflected back 14. FIG. 8 also discloses that there may be a doctor blade 31 for removing the solid matter 8 from the belt 2.

FIG. 9 discloses that an acoustic wave generator 11 may be adjusted not only linearly but also by turning 32a, 32b it relative to at least one turning axis under control of a control unit CU. This way orientation of the acoustic wave generator 11 and the generated acoustic waves 12 can be changed. When a reflector 13 is utilized, it may also be arranged to be adjustable linearly and by turning 32c, 32d it in relation to one or more turning axis under control of the control unit CU. A further possibility is to utilize alternatively, or in addition to, an absorber below the belt 2. The absorber may be arranged to be movable in a similar manner as the shown reflector 13, or it may alternatively be immovably mounted.

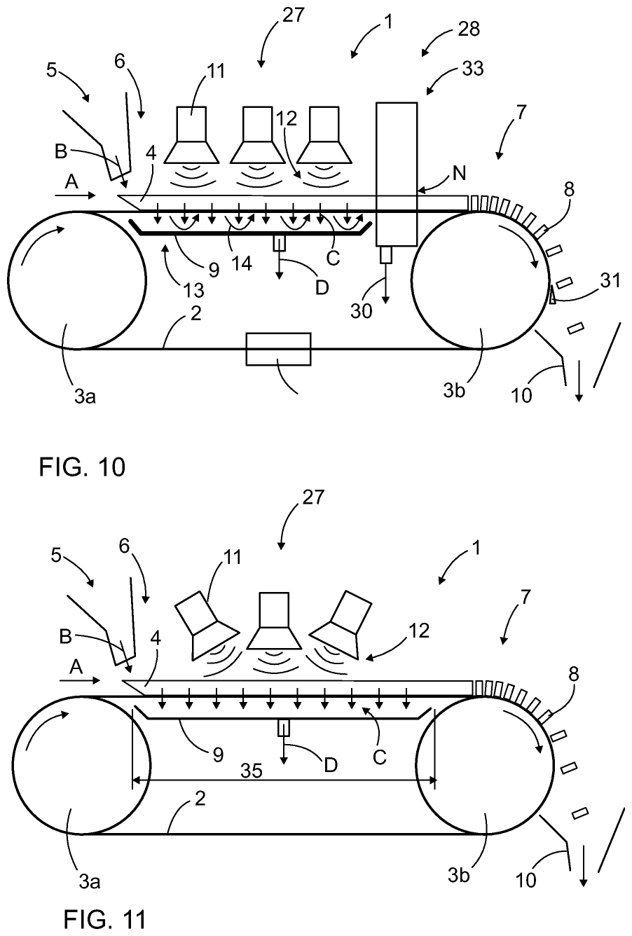

FIG. 10 discloses an apparatus 1 differing from the solution shown in FIG. 8 in that the additional solid-liquid separation device 28 or dewatering device comprises a suction cylinder, or a suction box configuration 33. Also, other mechanical solid-liquid separation apparatuses and techniques can be implemented. One further alternative is that the additional dewatering device is a thermal drying device.

FIG. 10 further discloses that there may be a belt washer 34 for keeping the belt 2 clean and permeable.

FIG. 11 discloses an apparatus that differs from the previously disclosed apparatuses in that there are several acoustic wave generators 11 which are orientated differently relative to each other. By utilizing different relative orientations for the generated acoustic waves 12, it is possible to intensify the solid-liquid separation process. FIG. 11 further discloses that the acoustic treatment section 27 has a range 35 extending from a roll 3a up to a roll 3b. Thus, the acoustic treatment section 27 covers an area extending from a feed end to a discharge end.

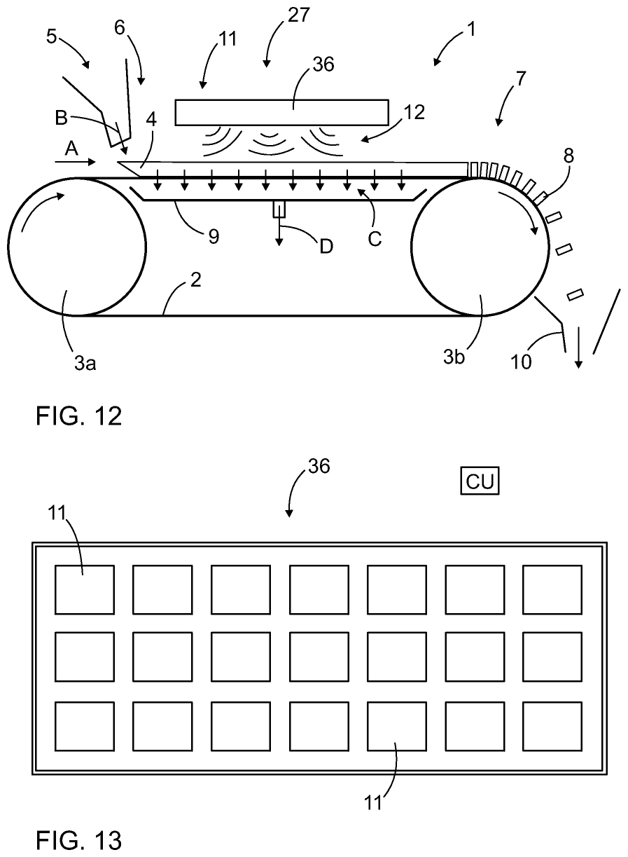

FIG. 12 discloses an acoustic wave generator panel or module 36 arranged above a belt and sludge 4 or material on it. The module 36 comprises several acoustic wave generators 11 as it is shown in FIG. 13 and seen from the belt side upwards. A plurality of acoustic wave generators 11 can be controlled by means of a control unit CU so that different arrays of acoustic waves 12 can be produced. The acoustic wave generators may be controlled electrically to orientate the acoustic waves, and also, magnitudes of produced acoustic waves can be controlled independently. The module 36 may be dimensioned to extend sideways from edge to edge and may cover a large range in longitudinal direction of the belt 2 whereby there may be a large acoustic treatment section 27. Alternatively, two or more modules 36 may be implemented to cover the large acoustic treatment section 27.

The figures and their description are intended only to illustrate the idea of the invention. However, the scope of protection of the invention is defined in the claims of the application.

1. An apparatus for solid-liquid separation, wherein the apparatus comprises:
an endless belt configured to be driven around at least two rotating rolls and wherein the belt is made of liquid permeable filter medium material;
a receiving section wherein sludge to be filtered is configured to be fed on an upper surface of the belt;
a discharge section wherein solid material separated from the fed sludge is configured to discharged from the upper surface of the belt;
at least one tray structure below the belt for receiving liquid passing through the belt; and
at least one acoustic wave generator for producing acoustic waves, located above the belt and arranged to direct the acoustic waves towards the sludge to be filtered;
wherein the belt is in gaseous atmosphere whereby medium for propagation of the acoustic waves is gas.

2. The apparatus according to claim 1, wherein
the acoustic wave generator is configured to produce infrasound with frequency below 20 Hz.

3. The apparatus according to claim 1, wherein the acoustic wave generator is configured to produce acoustic waves having frequency on range of audible sound.

4. The apparatus according to claim 1, wherein the belt and the acoustic wave generator are surrounded by ambient air.

5. The apparatus according to claim 1, wherein the apparatus is configured to be operated at atmospheric pressure.

6. The apparatus according to claim 1, wherein the apparatus is a pressure belt filter wherein pressure difference (P1-P2) is generated between opposite sides of the belt carrying the sludge to be filtered.

7. The apparatus according to claim 1, wherein the belt comprises carbon fibre material.

8. The apparatus according to claim 1, wherein the acoustic wave generator comprises:
at least one signal generator for producing signals;
at least one amplifier for amplifying the produced signals; and
at least one loudspeaker for producing acoustic waves in response to the received amplified signals.

9. The apparatus according to claim 1, wherein the acoustic wave generator comprises at least one mechanical acoustic wave generator

10. The apparatus according to claim 1, wherein the acoustic wave generator comprises at least one pneumatic acoustic wave generator.

11. The apparatus according to claim 1, wherein the apparatus is provided with a sound absorbing arrangement surrounding the apparatus for preventing the acoustic waves spreading to the environment surrounding the apparatus.

12. The apparatus according to claim 1, wherein the apparatus comprises at least one acoustic wave reflector on opposite side of the belt for reflecting the acoustic waves backwards and for producing reflected waves.

13. A method for solid-liquid separation, the method comprising:
using a belt filter for separating liquid and solid material from a sludge to be filtered;
driving an endless belt, which is made of liquid permeable filter medium material, around at least two rotating rolls;
feeding the sludge on an upper surface of the belt at a receiving section and discharging solid material at a discharge section;
collecting liquid penetrated through the liquid permeable belt underneath the belt
executing the solid-liquid separation in gaseous atmosphere; and
intensifying the solid-liquid separation by directing acoustic waves from above the belt towards the sludge which is transported on the belt.

14. The method according to claim 13, comprising causing oscillation to solid particles of the sludge spread on the belt by means of the acoustic waves and intensifying penetration of the liquid through the permeable belt by means of the oscillation of the solid particles.
